(19) United States
(12) Patent Application Publication
(10) Pub. No.: US 2007/0103843 A1
(43) Pub. Date: May 10, 2007

(54) Electrostatic mems components permitting a large vertical displacement

(75) Inventors: Julien Charton, Brignoud (FR); Claire Divoux, Grenoble (FR)

Correspondence Address: OBLON, SPIVAK, MCCLELLAND, MAIER & NEUSTADT, P.C., 1940 DUKE STREET, ALEXANDRIA, VA, 22314, US

(73) Assignees: COMMISSARIAT A L'ENERGIE ATOMIQUE, PARIS (FR); CENTRE NATIONAL DE LA RECHERCHE SCIENT., PARIS (FR)

(21) Appl. No.: 10/583,718

(22) PCT Filed: Dec. 23, 2004
(86) PCT No.: PCT/FR04/50759

§ 371 Date: Jun. 20, 2006

(30) Foreign Application Priority Data
Dec. 26, 2003 (FR) 03 51211

(51) Int. Cl. H01T 23/00

(52) U.S. Cl. 361/233

(57) ABSTRACT

An electrostatic actuation device, including a flexible electrode, having a first and a second end, at least part of the flexible electrode being mobile relative to a substrate, two electrodes fixed relative to the substrate, and a mechanism for forming two pivots of the flexible electrode, located between the two ends of the flexible electrode.

### TECHNICAL FIELD AND PRIOR ART

The invention relates to an electrostatic actuation device with improved mechanical performance.

A particular electrostatic actuation, for which a mobile electrode docks or is flattened against and along an insulator separating it from a fixed electrode, this movement being performed progressively and almost linearly with the applied voltage, is called actuation of the “zipping” type, or <<with progressive closing or with sliding rail>>.

Known devices, operating on this principle, are described in the article by J. Gravensen et al. <<A New Electrostatic Actuator providing improved Stroke length and Force>>, MEMS'92 or in the document WO 92/22763.

Now, none of the existing devices allows vertical travel greater than the thickness of the structures making it up.

In general, existing devices do not create significant displacement either, with a relatively significant force.

The problem of finding a new device is posed accordingly

Significant displacement may preferably be obtained with such a device.

### DESCRIPTION OF THE INVENTION

The invention first relates to a device or an electrostatic microactuation device, comprising:
at least one flexible electrode or mobile electrode relative to a substrate,
at least one electrode, fixed relative to the substrate,
means forming at least one pivot of the flexible electrode, or at least one portion or point of this flexible electrode.

The invention applies a flexible electrode, which will pivot about means forming a pivot when a voltage is applied between the mobile electrode and the fixed electrode or the fixed electrodes.

The mobile part of the mobile electrode may act as a lever arm to transmit movement to, for example, a load located in a mobile portion of this electrode or at its mobile end.

With the means forming a pivot, a pivot effect without a hinge (difficult to achieve), and without torsion arms (subject to parasitic translations) may be obtained.

The invention furthermore has no need for return arms found in the majority of other electrostatic actuators, because the flexible electrode provides the required mechanical restoring force on its free portion.

The invention allows displacement of a free portion or a free end of the electrode, perpendicularly to the substrate, a displacement which may be of any amplitude, typically from a few microns to a few tens of microns (for example from 5 μm to 50 μm or 100 μm), and especially larger than the average thickness of layers encountered in the field of microelectronics, an average thickness which may for example be of the order of several um, for example between 1 μm and 5 μm.

This is advantageous because in this field it is difficult to produce thick structural or sacrificial layers, which may provide displacement beyond a few μm.

A load may be placed on the flexible electrode, on the side of a mobile end or on a mobile portion, for example between two pivots. This load may be a mechanical load, and/or an electrical contact, and/or an electrical or optical component or even a membrane, especially forming a mirror.

Each fixed electrode is preferably located between means forming a pivot and an end of the flexible electrode adjacent to these means.

Each fixed electrode and the mobile electrode may be separated by an insulating layer, this insulating layer being on the substrate or on the mobile electrode.

The means forming a pivot may comprise one or more blocks, fixed relative to the substrate, each block advantageously capable of having a rounded end.

According to one alternative, the means forming a pivot comprise at least one arm positioned laterally relative to the flexible electrode, or two arms positioned on either side of this electrode.

The invention likewise relates to an electrostatic actuation device, comprising:
a flexible electrode, having a first and a second end, at least part of this electrode being mobile relative to a substrate,
two electrodes, fixed relative to the substrate,
means, forming two pivots of the flexible electrode, located between the two ends of the flexible electrode.

Preferably, each of the two fixed electrodes, or at least part of each of these fixed electrodes, is located opposite a section of the mobile electrode located between one of the means forming a pivot and the end of the electrode which is the closest to these means.

The invention likewise relates to a method for producing an electrostatic actuation device, comprising:
forming a first part comprising a flexible electrode, having a first and a second end,
forming a second part comprising a substrate, two electrodes, fixed relative to the substrate, and means for forming two pivots of the flexible electrode,
assembling the first and second parts, at least part of the flexible electrode being mobile relative to a substrate after assembly, the means forming two pivots of the flexible electrode being located between both ends of the flexible electrode.

Assembly may be done by bonding, or sealing, or by simple contact, by depositing one part onto the other.

Such a method may furthermore comprise a step for forming a dielectric layer on the mobile electrode and/or on at least both fixed electrodes and optionally on the blocks.

The invention likewise relates to a method for producing a deformable membrane, comprising:
producing an electrostatic actuation device according to the invention,
forming a membrane, and means for fixing this membrane to the flexible electrode.

The membrane, and the means for fixing this membrane to the flexible electrode, may be formed on or with the flexible electrode.

For example, the membrane may act as, or be, the membrane of a mirror or a wave front corrector.

A device according to the invention may be made in at least two parts, which are then simply stacked on top of one another and assembled, or simply placed on top of one another. This therefore decreases the complexity of each part, and for each part, technologies may be used which are very different from those used for the other part. This also allows the device to be disassembled for inspection or repairs.

The invention also relates to a method for operating a device according to the invention, wherein:
a potential difference is applied between the mobile electrode and each fixed electrode, the so-called first and second fixed electrodes respectively, this potential difference generating an attractive electrostatic force between both electrodes of each pair of electrodes (mobile electrode, fixed electrode), such that:
the means forming pivots are support points for the mobile structure, when the latter is attracted by one and/or the other of the fixed electrodes, the central part of the flexible electrode, or the part of this flexible electrode located between the means forming pivots, either moving or rising and falling, under the effect of mechanical forces, while the lateral parts are subjected to electrostatic forces.

The invention also relates to a method for operating a device according to the invention, wherein:
a potential difference is applied between the mobile electrode and each fixed electrode, the so-called first and second fixed electrodes respectively, this potential difference generating an attractive electrostatic force between the two electrodes of each couple of electrodes (mobile electrode, fixed electrode), such that:
if the potential difference between the first fixed electrode and the mobile electrode is decreased, and if the potential difference between the second fixed electrode and the mobile electrode is increased, the mobile structure tips towards the first fixed electrode gradually,
if the potential difference between the first fixed electrode and the mobile electrode is increased, and if the potential difference between the second fixed electrode and the mobile electrode is decreased, the mobile structure tips towards the second fixed electrode gradually,
if the potential difference between the first fixed electrode and the mobile electrode is decreased, and if at the same time the potential difference between the second fixed electrode and the mobile electrode is decreased, the mobile structure moves down to the substrate, along an axis known as axis ZZ′,
if the potential difference between the first fixed electrode and the mobile electrode is increased, and if at the same time the potential difference between the second fixed electrode and the mobile electrode is increased, the mobile structure moves up as it moves away from the substrate, along the ZZ′ axis.

### BRIEF DESCRIPTION OF THE DRAWINGS

FIG. 1 illustrates a first embodiment of the invention,

FIG. 2 illustrates another embodiment of the invention, with a symmetrised structure,

FIGS. 3A and 3B illustrate steps for producing a device according to the invention,

FIGS. 4A to 4F illustrate steps for producing a device according to the invention.

### DETAILED DISCUSSION OF PARTICULAR EMBODIMENTS

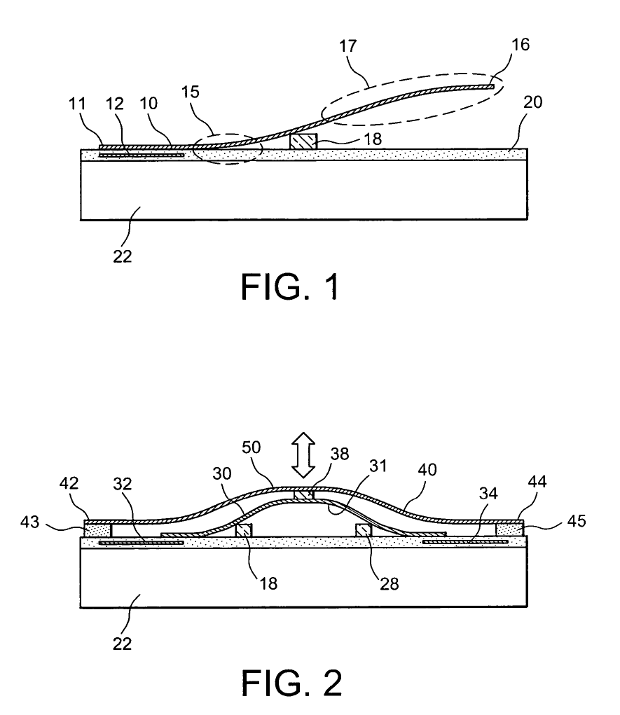

An example of a device according to the invention is illustrated in FIG. 1.

A fixed electrode 12 is located opposite a mobile or flexible electrode 10. A point, or an area, of this flexible electrode, rests on a stop or a block or a pivot 18, positioned with lateral offset, along the direction XX′, relative to the free end 16 of the flexible electrode which may be the location of a load. The latter is for example a mechanical load or a mechanical or electrical contact or an electrical or optical component. The load is therefore on the free side 17 of the electrode 10, or in the vicinity of the end 16, the so-called free end, i.e. on the side of the electrode 10 not located opposite the fixed electrode 12 or located between the area or section of the flexible electrode resting on the pivot and the free end of the flexible electrode. The load may be positioned on either face of the electrode 10.

The pivot 18 is located between the free end 16 and the end 11 of the electrode 10 which, when operating, is fixed or immobile relative to the substrate.

Subsequently, this end 11 will also be called a fixed end, which does not mean that it is necessarily fixed to the substrate (even though it may be).

The pivot 18 is for example substantially located towards the middle of the electrode 10 along the direction XX′.

The fixed electrode is located at the height of, or opposite a section of the flexible electrode between the end 11 and the pivot 18, or cooperates with such a section as to attract it by an electrostatic effect.

This assembly is also called an actuator.

The mobile structure 10 is insulated from the fixed electrode 12 by one layer, or by several insulating layers 20. The whole rests on a substrate 22.

The insulating layer is located on the fixed structure, as illustrated in FIG. 1, but it may also be on the mobile structure, the latter comprising for example a bilayer consisting of an insulating layer and an electrode layer. The same applies to the pivot 18.

The whole rests on a substrate 22.

The pivot 18 keeps a point of the mobile electrode at a minimal height, optionally at a fixed height, relative to the substrate 22. This height is measured along the ZZ′ axis, perpendicular to the plane of the insulating layer 20.

According to one example the pivot has a height between 1 μm and 10 μm or 20 μm for example.

As for the flexible electrode 10, it has a length L which may be of the order of a few hundred μm or even between 50 μm and 1 mm for example.

The travel or amplitude of the movement of the free end 16 may, under these conditions, be of the order of a few microns to a few tens of microns, and for example is between 5 μm or 10 μm and 100 μm or 150 μm.

The width of the electrode 10, measured along a direction perpendicular to the plane of FIG. 1, is of the order of a few tens of μm or a few hundreds of μm, for example between 20 or 50 μm and 500 μm or 1 mm.

Its thickness may be between 500 nm and 5 μm, for example equal to about 1 μm.

All these values are given by way of indication and devices according to the invention may be made with numerical values outside the ranges indicated hereinabove.

A potential difference is applied between the flexible or mobile 10 electrode and the fixed electrode 12. This potential difference generates an attractive electrostatic force between these two electrodes, and in a contact area 15 located between the end 11 and the pivot or the block 18. This force is easy to control with the potential difference. Means for controlling this potential difference may be provided, but they are not illustrated in the figure. The electrode 10 and the block may be made of a conducting or semiconducting material, so that a voltage may be applied to the electrode 10 via the block 18.

The flexible electrode 10 exerts an elastic force, and tends to resume its original rectangular shape, resulting in a tendency to reduce the contact area 15.

If the potential difference (pd) between the fixed electrode 12 and the electrode 10 is decreased, the intrinsic stiffness of the electrode 10 brings the load back down, and the lever arm 17 therefore moves down along the ZZ′ axis, towards the substrate 22.

If the pd between the fixed electrode 12 and the electrode 10 is increased, the lever arm 17 moves upwards along the ZZ′ axis, and therefore moves the load 16 away from the substrate 22. This part 17 of the electrode 10 located on the other side of the pivot 18 relative to the fixed electrode is subject to a mechanical restoring force.

The pivot 18 is a support point for the mobile structure. The electrode 10, or rather the part of this electrode located opposite the fixed electrode 12, docks or is flattened against and along the insulator 20, this movement, as well as the displacement of the free part 17, occurring gradually and almost linearly with the applied voltage.

In FIG. 1, this pivot is a block. The apex of this block, or the contact area between the block and the electrode 10, may be rounded to facilitate pivoting of the membrane, to limit parasitic horizontal movements, along the XX′ axis, and also limit wear on the mobile electrode in its contact area with the block. Other means may be applied to create the pivot: for example a mechanical arm on one side of the electrode 10, two mechanical arms on either side of the electrode 10, the advantage of which is to limit lateral movement (perpendicular to the plane of FIG. 1) of this point.

The pivot 18 may be constructed in the mobile part, or in the fixed parts. It may be placed below, or in the plane of the mobile part 10.

A device according to the invention therefore comprises:
a flexible electrode, whereof at least one end is, when operating, fixed relative to a substrate, and whereof another end is mobile relative to this substrate, part of the electrode located between these two ends being mobile relative to the substrate,
at least one electrode, fixed relative to the substrate,
means forming a pivot of the flexible electrode, and located between its fixed end and its mobile end.

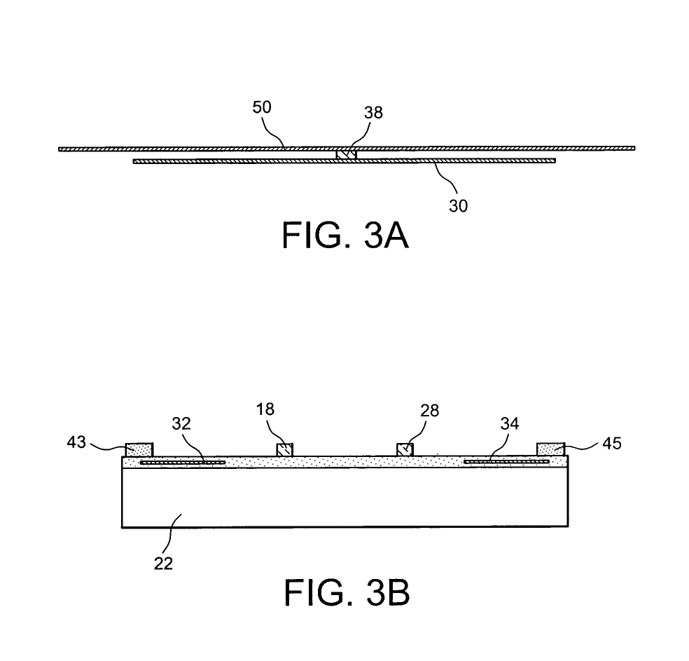

FIG. 2 shows, in a side view, an embodiment where the structure is symmetrised, allowing the parasitic rotations transmitted to the useful load 16 and appearing in the asymmetrical embodiment of FIG. 1, to be suppressed.

According to this embodiment of FIG. 2, a fixed electrode 32, 34 is located opposite each end of a mobile or flexible 30 electrode, whereof two points each rest on a stop or a block or a pivot 18, 28, or opposite a section of this flexible electrode located between the end in contact with the insulating layer and the pivot farthest from this end. These two blocks or pivots may be positioned on either side of the location 36 of a load, for example a mechanical load or a mechanical or electric contact or an electrical or optical component.

Here again, the mobile structure 30 is insulated from the fixed electrodes 32, 34 by one, or more, insulating layers 20 located on the fixed structure, as illustrated in FIG. 2, but which may also be on the mobile structure, as already described hereinabove.

The dimensions of the mobile membrane, and the height of the pivots 18, 28 may be identical or similar to those already indicated hereinabove in connection with FIG. 1.

Similarly, the pivots may have the shape of blocks, optionally with a rounded apex for the aforementioned reasons, or may have the shape of one or two lateral arms.

A potential difference is applied between the mobile electrode 30 and each fixed electrode 32, 34. This potential difference generates an attractive electrostatic force between the two electrodes of each couple of electrodes (mobile electrode, fixed electrode). This force is easy to control with the potential difference. Means for controlling this potential difference are provided but not shown in the figure. The membrane as well as the blocks may be made of a conducting or semiconducting material, or may comprise elements made of such materials, allowing a voltage to be applied to the membrane via the blocks 18, 28. It is also possible to make connection holes, then to deposit polycrystalline Si, prior to etching the mobile membrane and releasing it (this step being explained hereinbelow in relation to a production method).

If the potential difference (pd) between the fixed electrode 32 and the mobile electrode 30 is decreased, and if the pd between the fixed electrode 34 and the mobile electrode 30 is increased, the mobile structure tips gradually towards the fixed electrode 32.

If the pd between the fixed electrode 32 and the mobile electrode 30 is increased, and if the pd between the fixed electrode 34 and the mobile electrode 30 is decreased, the mobile structure tips gradually towards the fixed electrode 34.

If the potential difference (pd) between the fixed electrode 32 and the mobile electrode 30 is decreased, and if at the same time the pd between the fixed electrode 34 and the mobile electrode 30 is decreased, the mobile structure, and therefore the load 16, moves down to the substrate, along the ZZ′ axis.

If the potential difference (pd) between the fixed electrode 32 and the mobile electrode 30 is increased, and if at the same time the pd between the fixed electrode 34 and the mobile electrode 30 is increased, the mobile structure, and therefore the load 16, rises as it moves away from the substrate, along the ZZ′ axis.

The pivots 18, 28 thus are support points for the mobile structure, when the latter is attracted by one and/or the other of the fixed electrodes 32, 34: in fact, the central part 31 of the membrane, or the part located between the pivots 18, 28, shifts, or rises and moves down, under the effect of mechanical forces, while the lateral spans are subject to electrostatic forces.

The invention therefore also relates to an electrostatic actuation device, comprising:
a flexible electrode 10, having two ends, this electrode being mobile relative to a substrate;
two electrodes 32, 34, fixed relative to the substrate,
means 18, 28, forming two pivots of the flexible electrode, and located between the two ends of the flexible electrode.

The ends of the flexible electrode are, when operating, fixed relative to a substrate, part of the electrode, located between these two ends, being mobile relative to the substrate.

This double actuator may be used for deforming a membrane 40 vertically or laterally, for example acting as a mirror or wave front corrector.

Such a membrane is fixed on the opposite side to the substrate at a point or an area of the mobile membrane 10 for example by a block 38. It is also fixed laterally, at its ends 42, 44, for example on the substrate 22 or on an insulating layer 20 which covers it. This attachment may be done by means of blocks 43, 45 produced advantageously during the same technological stage as for the blocks 18, 28.

It is possible to create a plurality of flexible electrodes, and a membrane 40. The assembly consisting of the membrane and the flexible electrodes may then be placed on a substrate comprising a matrix of pairs of rigid electrodes 32, 34 and corresponding pairs of blocks 18, 28 (FIG. 2) for each flexible electrode. The movement of the membrane 40 is then controlled by the movement of all the flexible electrodes. All or part of the control electronics may be integrated into the support of the rigid electrodes. A control device of the membrane 40, which may for example function as a deformable mirror, is produced in this way.

A method for producing a device according to the invention makes use of photolithography techniques, etching of substrates.

A flexible electrode may thus be formed in a layer on a first substrate, by etching. It is also possible to produce connection holes, and then to deposit material capable of making connections, such as for example polycrystalline Si, prior to etching the mobile membrane and releasing it.

The means forming a pivot and the fixed electrodes may be formed on a second substrate, by depositing and etching. These are for example made of polysilicon, and may be covered by a dielectric layer allowing them to be insulated from the mobile electrode. According to one alternative, it is the mobile electrode which may be covered by this dielectric layer.

The membrane and the second substrate may then be put in contact.

A method for producing an electrostatic actuation device according to the invention may therefore comprise:
a step for forming a flexible electrode on a first substrate,
a step for forming in a second substrate, means forming at least one pivot, and at least one fixed electrode relative to this second substrate.

A step for assembling or placing the flexible electrode and the second substrate in contact may optionally follow.

The number and the position of the blocks and the fixed electrodes are adapted for producing a device such as the one in FIG. 1 or FIG. 2.

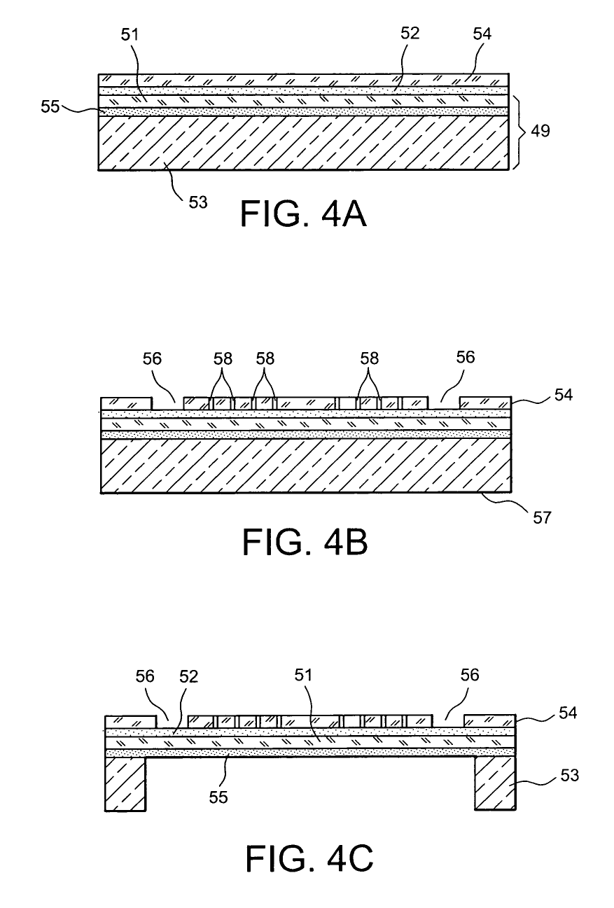

FIGS. 3A and 3B illustrate two steps for preparing a device according to FIG. 2, with:
a step for forming a flexible electrode 30 and a membrane 40 from a first substrate,
a step for forming in a second substrate 22, means forming two pivots 18, 28, and two blocks 43, 45 for holding two fixed electrodes 32, 34 relative to this second substrate.

Assembly of both of the thereby formed elements leads to the device of FIG. 2.

The invention may be embodied as an electrostatic MEMS component (Micro Electro Mechanical System) providing significant vertical and substantially linear displacement as a function of the voltage, while benefiting from a significant force.

The invention therefore enables a device according to the invention to be made from two distinct assembled parts.

The first part comprises the substrate 22, the fixed electrode 12 or the fixed electrodes 32,34, the block or the blocks 18, 28, and optionally the blocks 43, 45. The second part comprises the flexible electrode 16, 30, a load or the block 38 and the membrane 40.

The two parts may be assembled by bonding, sealing, or simply by depositing one part on top of the other.

This method is in particular applied to making a deformable mirror.

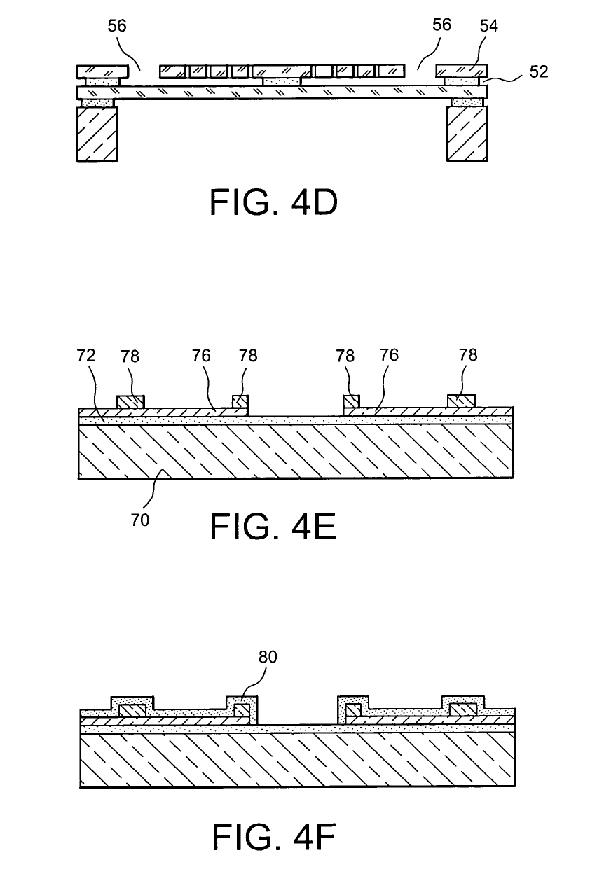

A production method of the invention will now be described, in connection with FIGS. 4A to 4F.

According to this method, one or more actuators are produced on one face of a substrate prior to releasing the assembly consisting of the membrane and the actuators.

This method uses a SOI 49 substrate.

According to a first step (FIG. 4A) a SOI 49 substrate is covered with an oxide layer 52 and a polysilicon layer 54, all of which are on the surface layer 51 of the SOI substrate.

Next (FIG. 4B) openings 56, 58 are made in the polysilicon layer 54, by way of photolithography and etching.

The wide openings 56 define the pattern of the polysilicon structures. The smaller openings 58 are in fact etching holes which will allow the polysilicon structures to be released.

Then, (FIG. 4C) the membrane is released by photolithography and etching from the rear face 57.

The next step (FIG. 4D) is deoxidation, therefore release of the membrane 54, carried out by etching the oxide layer 52 via the wide openings 56.

The membrane/actuator assembly is thereby produced.

A dielectric layer 72 (for example made of insulating oxide), fixed electrodes 76, blocks 78, as well as connection means addressing each actuator individually will now be created on a second substrate 70 (FIG. 4E). The fixed electrodes 76 and the blocks 78 are created in the polysilicon layer, resting on the layer 72. By etching, completed in two steps, two different thicknesses may be created, one for the blocks 78, the other for the electrodes 76.

The 4 blocks 78 shown in FIG. 4E form the 4 blocks 18, 28, 43, 45 of FIG. 2 and are therefore positioned correspondingly. In the same way, the electrodes 76 will correspond to the electrodes 32, 34 of this same FIG. 2.

Finally, (FIG. 4F) with oxidation or a deposit of any other dielectric layer 80 both electrodes may be insulated.

The first substrate 49, such as obtained and such as illustrated in FIG. 4D, may then be turned over, placed on the second substrate 70, as obtained at the end of stage 4F, to connect the mobile electrode by <<bonding>> (or molecular assembly).

To make a device such as that of FIG. 1, the procedure is as described hereinabove, but by adapting the number and position of the blocks and the fixed electrodes. The mobile electrode may also be made as specified hereinabove, by being fully released during the step of FIG. 4D.

1-19. (canceled)

20. An electrostatic actuation device, comprising:
a flexible electrode, having a first and a second end, at least part of the flexible electrode being mobile, or forming a mobile structure, relative to a substrate;
first and second fixed electrodes, fixed relative to the substrate; and
means for forming two pivots of the flexible electrode, located between the first and second ends of the flexible electrode, each fixed electrode being located, while the device is operating, opposite a section of the flexible electrode located between one of the means for forming two pivots and the end of the flexible electrode closest to the means for forming two pivots.

21. The device as claimed in claim 20, wherein a load is placed on or fixed to the flexible electrode, between its first and second ends or between the means for forming two pivots.

22. The device as claimed in claim 20, wherein the load is a mechanical load, and/or an electrical contact, and/or an electrical or optical component.

23. The device as claimed in claim 20, wherein the flexible electrode is connected via a block to a membrane.

24. The device as claimed in claim 23, wherein the membrane forms a mirror or wave front corrector.

25. The device as claimed in claim 20, wherein the mobile part of the mobile electrode is mobile according to at least the direction perpendicular to the substrate.

26. The device as claimed in claim 20, further comprising an insulating layer formed on the substrate and/or the flexible electrode.

27. The device as claimed in claim 20, wherein the means for forming two pivots comprises at least one block fixed relative to the substrate.

28. The device as claimed in claim 27, wherein each block has a rounded end.

29. The device as claimed in claim 20, wherein the means for forming two pivots comprises at least one arm positioned laterally relative to the flexible electrode, or two arms positioned on either side of the flexible electrode.

30. The device as claimed in claim 20, further comprising control means for each potential difference between the flexible electrode and each fixed electrode.

31. A method for producing an electrostatic actuation device, comprising:
forming, on a first substrate, a first part including a flexible electrode, having a first and a second end;
forming, in a second substrate, a second part including a substrate, two electrodes, fixed relative to the substrate, and means for forming two pivots of the flexible electrode; and
assembling or putting in contact the first and second parts, at least part of the flexible electrode being, after assembly, mobile relative to the substrate of the second part, the means for forming two pivots of the flexible electrode being located between the first and second ends of the flexible electrode, each fixed electrode being located, while the device is operating, opposite a section of the flexible electrode located between one of the means for forming two pivots and the end of the flexible electrode closest to the means for forming a pivot.

32. The method as claimed in claim 31, further comprising forming a dielectric layer on the mobile electrode.

33. The method as claimed in claim 31, further comprising forming a dielectric layer on at least the two fixed electrodes and the means for forming a pivot.

34. A method for producing a deformable membrane, comprising:
producing an electrostatic actuation device, as claimed in claim 31; and, forming a membrane, and fixing means to fix the membrane to the flexible electrode.

35. The method as claimed in claim 34, wherein the membrane acts as, or is, a membrane of a mirror or wave front corrector.

36. An operating method for a device as claimed in claim 20, in which:
a potential difference is applied between the flexible electrode and each of the first and second fixed electrodes respectively, the potential difference generating an attractive electrostatic force between the two electrodes of each couple of electrodes of the mobile electrode and each respective fixed electrode, such that:
the means for forming two pivots includes support points for the mobile structure, when the mobile structure is attracted by one and/or the other of the fixed electrodes, a central part of the flexible electrode, or a part of the flexible electrode located between the means for forming two pivots, moving, or rising and moving down, under an effect of mechanical forces, while lateral parts are subject to electrostatic forces.

37. The method as claimed in claim 36, in which:
if the potential difference between the first fixed electrode and the mobile electrode is decreased, and if the potential difference between the second fixed electrode and the mobile electrode is increased, the mobile structure tips gradually towards the first fixed electrode,
if the potential difference between the first fixed electrode and the mobile electrode is increased, and if the potential difference between the second fixed electrode and the mobile electrode is decreased, the mobile structure tips gradually towards the second fixed electrode,
if the potential difference between the first fixed electrode and the mobile electrode is decreased, and if at a same time the potential difference between the second fixed electrode and the mobile electrode is decreased, the mobile structure moves down to the substrate, along an axis,
if the potential difference between the first fixed electrode and the mobile electrode is increased, and if at a same time the potential difference between the second fixed electrode and the mobile electrode is increased, the mobile structure rises by moving away from the substrate, along the axis.

38. An operating method for a device as claimed in claim 20, in which:
a potential difference is applied between the mobile electrode and each of the first and second fixed electrodes respectively, the potential difference generating an attractive electrostatic force between the two electrodes of each couple of electrodes of the mobile electrode and each respective fixed electrode, such that:
if the potential difference between the first fixed electrode and the mobile electrode is decreased, and if the potential difference between the second fixed electrode and the mobile electrode is increased, the mobile structure tips gradually towards the first fixed electrode,
if the potential difference between the first fixed electrode and the mobile electrode is increased, and if the potential difference between the second fixed electrode and the mobile electrode is decreased, the mobile structure tips gradually towards the second fixed electrode,
if the potential difference between the first fixed electrode and the mobile electrode is decreased, and if at a same time the potential difference between the second fixed electrode and the mobile electrode is decreased, the mobile structure descends to the substrate, along an axis,
if the potential difference between the first fixed electrode and the mobile electrode is increased, and if at a same time the potential difference between the second fixed electrode and the mobile electrode is increased, the mobile structure rises by moving away from the substrate, along the axis.

39. An electrostatic actuation device, comprising:
a flexible electrode, having a first and a second end, at least part of the flexible electrode being mobile, or forming a mobile structure, relative to a substrate, according to at least a direction perpendicular to the substrate;
first and second fixed electrodes, fixed relative to the substrate; and
means fixed relative to the substrate, for forming two pivots of the flexible electrode, located between the first and second ends of the flexible electrode, each fixed electrode being located, while the device is operating, opposite a section of the flexible electrode located between one of the means for forming two pivots and the end of the flexible electrode closest to the means for forming two pivots.

40. The device as claimed in claim 28, wherein a load is placed on or fixed to the flexible electrode, between its first and second ends or between the means for forming two pivots.

41. The device as claimed in claim 39, wherein an insulating layer is formed on the substrate and/or the flexible electrode.

42. The device as claimed in claim 39, wherein said means for forming two pivots comprises at least one arm positioned laterally relative to the flexible electrode, or two arms positioned on either side of the flexible electrode.
